(19) United States
(12) Patent Application Publication
(10) Pub. No.: US 2011/0096765 A1
(43) Pub. Date: Apr. 28, 2011

(54) BRUTE FORCE CHANNEL DECODING

(76) Inventor: David F. Chappaz, Cambridge (GB)

(21) Appl. No.: 12/672,810

(22) PCT Filed: Jul. 2, 2008
(86) PCT No.: PCT/GB2008/002300

§ 371 Date: Jan. 4, 2011

(30) Foreign Application Priority Data
Aug. 10, 2007 (GB) 0715648.2

(51) Int. Cl. H04B 7/216

(52) U.S. Cl. 370/342

(57) ABSTRACT

An embodiment of the present invention provides that pre-calculated code words corresponding to possible input bit sequences are stored in a UE, and then a similarity matching operation performed between a received coded bit sequence and the stored code words can be performed to identify that code word which most closely matches to the received sequence. Because the stored code words are associated with the original input bit sequences which produced those code words, by identifying the most closely correlating code word to a received coded sequence, then the input sequence which generated the matching code word can also be identified, and output as the decoder output. In this way, a more efficient decoding operation is obtained as decoding is no longer dependent upon a Viterbi decoding operation and moreover it is no longer necessary to implement a Viterbi decoder, instead merely requiring storage for the pre-calculated code words. In the specific case of the HS-SCCH Part 1 a code word table comprising 256 40 bit is required. This is significantly easier to implement and is more efficient in terms of chip area, than providing a dedicated Viterbi decoder to decode the HS-SCCH Part 1 channel.

### TECHNICAL FIELD

The present invention relates to a method and apparatus for decoding a control channel using similarity matching with possible code words, and in particular in a preferred embodiment to such a method and apparatus where the control channel is part of a radio interface of a mobile telecommunications network.

### BACKGROUND TO THE INVENTION AND PRIOR ART

High Speed Downlink Packet Access (HSDPA) is an enhancement made by the 3rd Generation Partnership Project (3GPP) to Release 5 of the W-CDMA/UTRAN mobile telecommunication standards. It enables higher downlink data rates and greater base station capacity, and represents an important upgrade to 3G system capabilities. HSDPA introduces a new High Speed Shared Downlink Channel (the HS-DSCH) as well as additional downlink and uplink control channels to support the high speed downlink transmission. In particular, the High Speed Shared Control CHannel (HS-SCCH) is a downlink channel which signals the downlink transmission format used for the HS-DSCH to the different users. The High Speed Dedicated Physical Control CHannel (HS-DPCCH) is an uplink physical channel used to transmit feedback information to the base station. Such feedback information includes hybrid-ARQ (H-ARQ) information, as well as adaptive modulation and coding (AMC) information. In this respect, HSDPA makes use adaptive modulation in that whereas usually it makes use of QPSK, when signal conditions are good the modulation can be changed to 16 QAM. Moreover, the symbol constellation for 16 QAM may be altered dependant on the signal conditions.

FIG. 1 illustrates the general arrangement of the new channels introduced by HSDPA. More particularly, a user equipment (UE) 10, such as a user mobile device, communicates with a Node B 20 (the base station) via the channel as shown. In particular, as mentioned, the high speed downlink shared channel provides a transport channel for data to be transported. The HS-DSCH is mapped onto up to 15 physical channels (HS-PDSCH) for transmission.

In order to provide information concerning the HS-DSCH to the UE 10, the Node B 20 also transmits the high speed shared control channel (HS-SCCH) 14. Up to four HS-SCCH may be received by the UE 10 at the same time.

To provide feedback from the UE 10 to the Node B 20, the UE 10 transmits the high speed dedicated physical control channel (HS-DPCCH) 16, which, as mentioned, contains signal quality information, as well as data acknowledgements for use in the hybrid-ARQ protocol employed by HSDPA.

In the present specification we are concerned with the transmission of the high speed shared control channel (HS-SCCH) from the Node B 20 to the UE 10, and in particular with the accurate decoding of the HS-SCCH at the UE. Details of the multiplexing and channel coding used for the HS-SCCH at a Node B are given in the 3GPP document 3GPP TS 25.212 V5.10.0, “Multiplexing and Channel Coding (FDD)” of June 2005, the relevant portions of which referenced below are incorporated herein by reference. This document in particular sets out the format, channel coding, and multiplexing which is applied to the HS-SCCH prior to transmission in physical slot 0. The following description of the prior art multiplexing and encoding used in HS-SCCH is derived from this document.

With reference to FIG. 2 the HS-SCCH is split into two parts, Part 1 comprising 8 bits, and Part 2 comprising 29 bits. FIG. 2 illustrates the contents of the two parts of the HS-SCCH, from which it will be seen that Part 1 comprises seven bits of data referring to the channelisation code set mapping used in the HS-DSCH. Additionally, Part 1 also contains a 1 bit flag indicating the modulation scheme used on the HS-DSCH. In this respect, as mentioned HSDPA makes use of either QPSK, or 16 QAM, and hence a single bit is sufficient to distinguish between the two modulation schemes available.

Further as shown in FIG. 2, Part 2 of the HS-SCCH comprises 29 bits, with six bits being related to the transport block size, three bits identifying the hybrid ARQ process ID, and a further 3 bits relating to redundancy and the modulation constellation version being used. A new data indicator takes up 1 bit, and then a 16 bit cyclic redundancy check is added. The 16 bit CRC is calculated across both Part 1 and Part 2 of the HS-SCCH. Further details of each of the individual constituent parts of the HS-SCCH Part 1 and Part 2 are given in section 4.6 of 3GPP TS 25.212 V.5.10.0.

The HS-SCCH Part 1 and Part 2 are individually convolutionally coded, such that Part 1 can be individually decoded from Part 2. The reason for this is that the HS-SCCH Part 1 contains information which the UE requires as soon as possible, in order to be able to receive the HS-DSCH. The coding applied to the HS-SCCH Part 1 in a Node B, and the decoding used in a conventional UE to decode the HS-SCCH Part 1, will now be described with respect to FIGS. 3 and 4.

Turning to FIG. 3, FIG. 3 illustrates the coding which is used in a Node B to code the HS-SCCH Part 1 bit sequence for transmission. Generally, the HS-SCCH Part 1 bits have tail bits added to them, and pre then subject to a rate ⅓ convolutional encoding. The resulting convolutionally encoded bits are then subject to puncturing, and are then masked with the encoded user equipment ID (UE-ID) of the UE for which the HS-SCCH is intended. The resulting UE masked bits are then transmitted in physical slot 0.

More particularly, as shown in FIG. 3 the HS-SCCH Part 1 comprising 8 bits have 8 tail bits added, all of which are 0, by tail bit adder 32. This results in 16 bits, being the 8 bits of the HS-SCCH Part 1, plus the eight 0 tail bits. These 16 bits are then input into a rate ⅓ convolutional encoder 34. The rate ⅓ convolutional encoder 34 is defined in section 4.2.3.1 of 3GPP TS 25.212 V.5.10.0, and in particular is shown in FIG. 3(b) of that document. This results in 48 convolutionally coded bits (z₁, z₂, . . . , z₄₈). These 48 convolutionally encoded bits are then input into bit puncturer 36, which punctures the coded bits according to a fixed puncture. More particularly bits z₁, z₂, z₄, z₈, z₄₂, z₄₅, z₄₇, and z₄₈ are punctured to obtain an output 40 bit sequence r₁, r₂, . . . , r₄₀. The 40 bit sequence of punctured convolutionally coded bits are then passed to a user equipment masking element 38, for masking with the encoded UE ID.

More particularly, each UE has a UE ID assigned to it comprising a 16 bit data word X_{UE1}, X_{UE2}, . . . , X_{UE16}. The UE-ID is typically the radio network temporary identifier (RNTI) for the HS-DSCH channel established by a UE. The HS-DSCH RNTI must be unique within the cell carrying the HS-DSCH. Further details are given in 3GPP TS 25.401 V 5.10.0, at section 6.1.7, incorporated herein by reference.

As shown in FIG. 3, the 16 bit UE has 8 tail bits added to it by tail bit adder 42. All of the tail bits are 0. The resulting 24 bits are then input to a rate ½ convolutional encoder 44. The rate ½ convolutional encoder is specified in section 4.2.3.1 of 3GPP TS 25.212 V 5.10.0. The rate ½ convolutional encoder outputs 48 convolutionally encoded bits (b₁, b₂, . . . , b₄₈). The 48 convolutionally coded bits are then input to a second bit puncturer 46, which punctures the convolutionally encoded bits according to a fixed puncture pattern, in this case the same pattern as was used by the bit puncturer 36 on the convolutionally encoded HS-SCCH Part 1 bits. That is, bit b₁, b₂, b₄, b₈, b₄₂, b₄₅, b₄₇ and b₄₈ are punctured to obtain the 40 bit UE specific masking code c₁, c₂, . . . , c₄₀. The 40 bit UE specific masking code is then input into the UE masker 38.

To perform the UE specific masking of the HS-SCCH Part 1, the UE masker 38 applies the following modulo-2 function, to generate 40 UE specific masked bits (s₁, s₂, . . . , s₄₀):

sₖ=(rₖ+cₖ)mod 2 for k=1, 2, . . . , 40

The 40 UE masked bits are then transmitted at slot 0. In this respect, the HS-SCCH uses a fixed spreading factor (128) and QPSK modulation.

FIG. 4 illustrates conventional decoding of the HS-SCCH Part 1 which is performed at a typical conventional UE. More particularly, slot 0 is received and subject to equalisation and demodulation, to produce 40 soft bits. Typically, the soft bits will be Log Likelihood Ratios (LLRs) indicating the detected bit value (0 or 1) and a confidence level in the bit detection. Usually, the LLRs take values from −32 to +32 with +32 indicating absolute confidence in a 0, and −32 indicating absolute confidence in a 1. The range may also be larger or smaller (and possibly unsigned, e.g. 0 to 63) depending how many bits are used for the soft-bits representation (5 bits in this example).

The soft bits are input into a UE de-masker 52, which is essentially an XOR gate. The other input to the XOR is the punctured convolutionally coded UE-ID sequence (c₁, c₂, . . . , c₄₀) (the UE masking code) which has been generated by the UE mashing code generation block 54. The UE masking code generation block 54 receives the UE-ID xᵤₑ₁, xᵤₑ₂, xᵤₑ₁₆ and performs the same, functions as tail bit adder 42, convolutional encoder 44, and bit puncturer 46 in the Node B encoder, described previously with respect to FIG. 3. Note that once the HS-DSCH RNTI has been established then the same UE ID is used from then on, and hence the UE masking code generator 54 need only generate the punctured convolutionally encoded UE ID sequence (c₁, c₂, . . . , C₄₀) once, whereupon the sequence can then be stored for repeated use.

The UE de-masker 52 uses the UE masking code to de-mask the received softbits, which, by operation of the XOR gate, will mean that some of the softbit signs are changed, although the soft bit confidence values are not altered. The de-masked soft bits are then input to a depuncturer 56, which adds into the sequence of 40 soft bits additional erasures (soft bits equal to 0) to compensate for the 8 bits which were removed by bit puncturer 36 in the Node B encoder. The sequence of 48 soft bits thus obtained are then input into a rate ⅓ convolutional decoder 58, which is usually a Viterbi decoder, trained to decode a bitstream which has been convolutionally encoded accorded to rate ⅓ convolutional encoder 34 used in the Node B encoder. As is well known in the art, the use of a Viterbi decoder provides the maximum likelihood sequence corresponding to the HS-SCCH Part 1 bit sequence which was originally input into the Node B encoder.

Thus, as has been described, within a typical conventional UE the HS-SCCH Part 1 sequence is decoded using a convolutional decoder, and typically a Viterbi decoder. Moreover, because the convolutionally coded bitstream has been punctured, a depuncturer 56 is also required to add in the erasure bits. As is known in the art, the use of a Viterbi decoder, whilst providing the maximum likelihood bit sequence as an output thereof, does not guarantee to absolutely accurately decode the received bitstream, to provide the original bit sequence. Additionally, implementation of a Viterbi decoder is relatively complicated, requiring, in an integrated circuit implementation, many logic gates taking up a significant silicon area. It would therefore be advantageous if a more accurate and efficient decoding technique could be provided in order to provide for decoding of the HS-SCCH Part 1.

### SUMMARY OF THE INVENTION

In order to address the above, an embodiment of the present invention provides that pre-calculated code words corresponding to possible input bit sequences are stored in a UE, and then a measure of similarity between a received coded bit sequence and the stored code words can be performed to identify that code word which most closely matches to the received sequence. Because the stored code words are associated with the original input bit sequences which produced those code words, by identifying the most closely matching code word to a received coded sequence, then the input sequence which generated the matching code word can also be identified, and output as the decoder output. In this way, a more efficient decoding operation is obtained as decoding is no longer dependent upon a Viterbi decoding operation and moreover it is no longer necessary to implement a Viterbi decoder, instead merely requiring storage for the pre-calculated code words. In the specific case of the HS-SCCH Part 1 a code word table comprising 256 entries of 40 bits each is required. This is significantly easier to implement and is more efficient in terms of chip area than providing a dedicated Viterbi decoder to decode the HS-SCCH Part 1 channel.

In view of the above, from a first aspect the present invention provides a method of decoding a received coded bit sequence, comprising the steps: obtaining a plurality of codewords which said coded bit sequence may possibly represent; for substantially each of the plurality of codewords, calculating a similarity measure with the received coded bit sequence to determine one of the codewords which most closely matches the coded bit sequence; identifying an input bit sequence which, when encoded in the same manner as the received coded bit sequence, produces said determined codeword; and outputting said identified input bit sequence to represent the decoded received coded bit sequence. The first aspect therefore has the advantages that, due to the similarity matching operation, more accurate decoding can be obtained at greater efficiency, as it no longer becomes necessary to implement maximum likelihood decoder, such as a Viterbi decoder.

In a preferred embodiment the received coded bit sequence is Part 1 of a High Speed Shared Control CHannel (HS-SCCH) of a High Speed Downlink Packet Access (HSDPA) downlink from a Node B to a UE. In this case the method is preferably performed at a UE. With such features the present invention can then be used in 3G equipment, and in particular 3G equipment implementing HSDPA, which provides for higher bit rates than have heretofore been possible.

In the preferred embodiment said obtaining step preferably includes storing said codewords, each codeword being stored so as to indicate the input bit sequence which, when encoded in the same manner as the received coded bit sequence, produces said codeword. By storing the codewords in advance, then the decoding operation can be quickly performed, reducing power consumption in the decoder, an important factor for mobile devices.

Preferably, said stored codewords are produced by encoding each possible value of the input bit sequence in the same manner of encoding as the received coded bit sequence, and storing each produced code-Word in a table. Storage in a table facilitates easy access to the codewords when required. Moreover, preferably the codewords are stored in order, such that the order of the codeword indicates the input bit sequence. By storing the codewords in order the table can be made smaller, as it is not necessary to store the actual bit sequences themselves, or an identifier of the bit sequences.

In an alternative embodiment, said obtaining step includes generating said codewords when required, each codeword being generated by encoding, in the same manner as the received coded bit sequence was encoded, a respective input bit sequence. By dynamically generating the codewords when required, the need for memory storage to store the codewords is eliminated.

In the preferred embodiment the similarity measure is preferably a correlation measure between the received coded bit sequence and an obtained codeword. This is particularly advantageous when the received coded bit sequence is represented using soft bits. Using a correlation operation is advantageous from a processing view, as it is practically easy to implement and represents very little processing overhead.

In an alternative embodiment the similarity measure is preferably a distance measure. This is particularly preferable when used with hard decision bits representing the received coded bit sequence. Preferably Hamming distances are used as they are relatively straightforward to compute.

From another aspect the invention provides a decoder for decoding a received coded bit sequence, the decoder comprising: a similarity measurement calculator configured in use to calculate a similarity measure for substantially each of a plurality of codewords which said received coded bit sequence may possibly represent so as to determine one of the plurality of codewords which most closely matches the received coded bit sequence; a bit sequence identifier configured in use to identify an input bit sequence which, when encoded in the same manner as the received coded bit sequence produces said determined codeword; and an output at which said identified input bit sequence is output so as to represent the decoded received coded bit sequence.

Within the second aspect the same advantages are obtained, as well as the same further features and associated advantages, as described above in respect of the first aspect.

### BRIEF DESCRIPTION OF THE DRAWINGS

Further features and advantages of the present invention will become apparent from the following description of embodiments thereof, presented by way of example only, and by reference to the accompanying drawings, wherein like reference numerals refer to like parts, and where:—

FIG. 1 is a diagram illustrating the arrangement of HSDPA channels of the prior art;

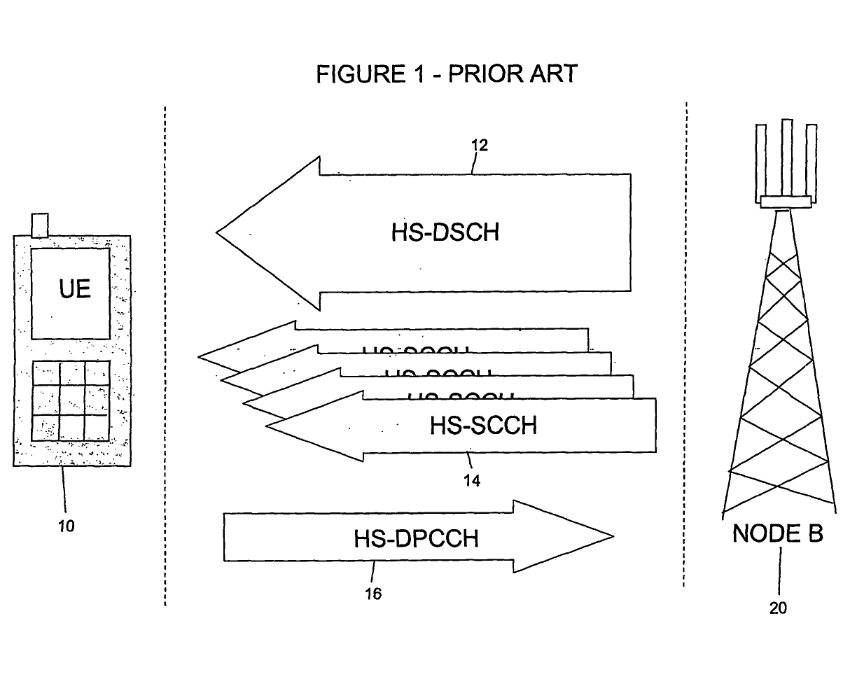

FIG. 2 is a diagram illustrating the arrangement of the HS-SCCH channel of the prior art;

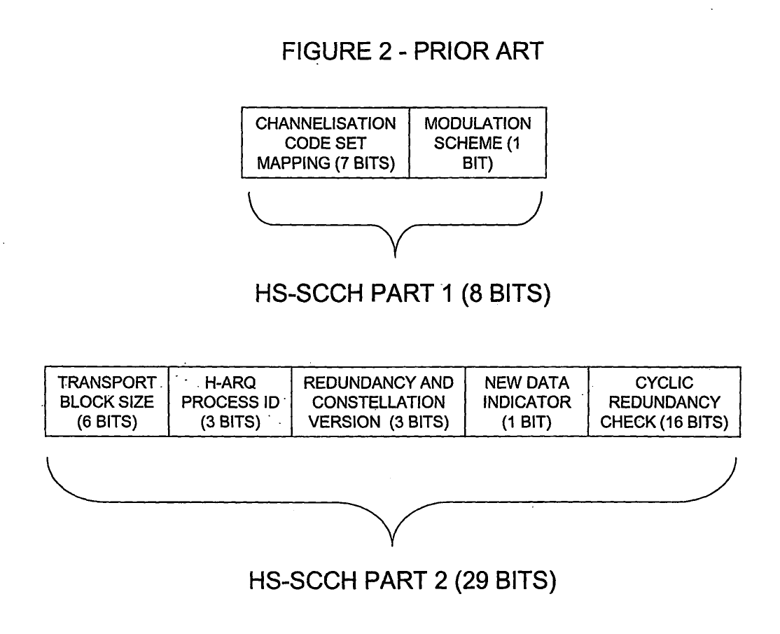

FIG. 3 is a block diagram of an encoder used in a conventional Node B for encoding the HS-SCCH Part 1 channel of the prior art;

FIG. 4 is a block diagram of a decoder used in a typical conventional UE for decoding the HS-SCCH Part 1 channel;

FIG. 5 is a block diagram of a decoder according to a first embodiment of the invention used in a UE for decoding the HS-SCCH Part 1 channel;

FIG. 6 is a table showing how code word sequences are stored in a first embodiment of the invention, and how the code word sequences are generated;

FIG. 7 is a flow diagram illustrating the decoding operations used in a decoder of the first embodiment of the present invention;

FIG. 8 is diagram containing information for illustrating a cross-correlation operation used in the embodiment of the invention;

FIG. 9 is a table of codeword sequences useful for understanding the mathematical basis of the embodiments.

### DESCRIPTION OF THE PREFERRED EMBODIMENT

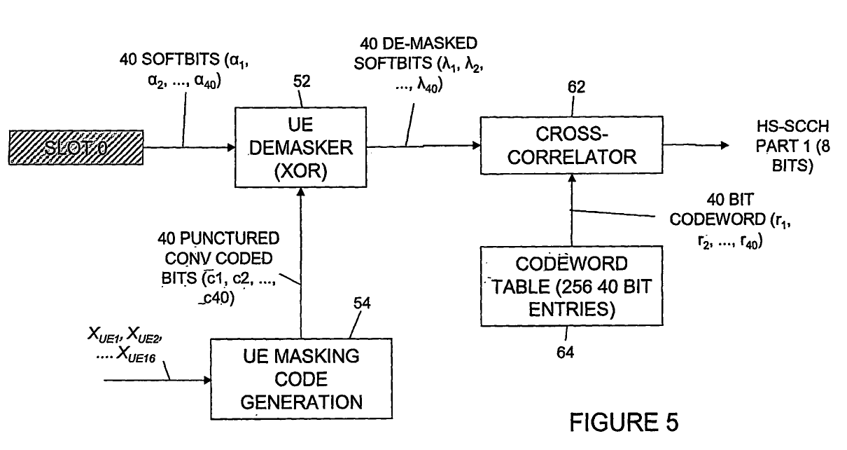

A preferred embodiment of the present invention will now be described with respect to FIGS. 5 to 8.

More particularly, FIG. 5 shows a decoder according to the preferred embodiment for decoding the HS-SCCH Part 1 channel. The decoder of FIG. 5 would typically be provided in the UE 10, such as a user mobile telephone, or the like. Of course, the UE 10 may be another device, other than a mobile telephone, such as, for example, a PDA or a computer 3G network card, such as a PCMCIA card, or the like, arranged to allow a computer, typically a laptop or notebook computer, to communicate via the mobile telecommunications network.

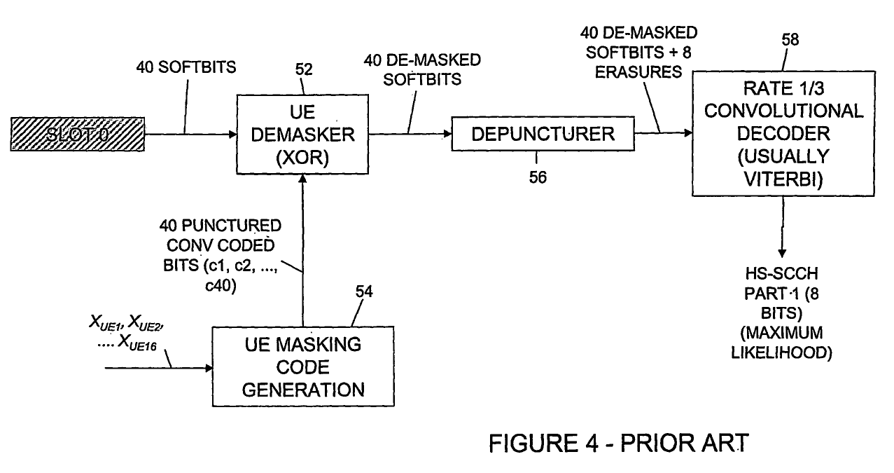

In whatever form of UE the embodiment of the invention is used, the decoder for the HS-SCCH Part 1 signal according to a present embodiment comprises a UE de-masker 52 and a UE masking code generator 50 which are the same as previously described in respect of the conventional decoder of the prior art in FIG. 4. That is, the de-masker 52 is typically an XOR gate, and the UE masking code generator takes the 16 bit UE ID (typically the HS-DSCH RNTI) and produces a punctured convolutionally coded variation thereof, in the same manner as described previously. Again, as described previously, because for any HSDPA session, once the UE ID has been assigned then the UE masking code will remain the same for that session, the UE masking code generator 54 need only calculate the UE masking code once, and thereafter it is stored for future use by the UE de-masker 52.

The UE de-masker 52 receives the equalised and demodulated soft bits corresponding to slot 0 in which the HS-SCCH Part 1 signal is transmitted, in the form of a sequence of 40 Log Likelihood Ratios (LLRs), as discussed previously with respect to the prior art. The UE de-masker 52 applies an XOR operation to the received LLRs with the UE masking code, to produce 40 de-masked soft bits λᵢ (λ₁, λ₂, . . . , λ₄₀). Effectively, the XOR operation, as in the prior art, merely serves to change the sign of some of the LLRs, and the confidence values therein are not themselves changed. The sequence of LLRs are, in the present embodiment, then input to a cross correlator 62, the operation of which is described later.

Additionally provided according to the preferred embodiment is a code word table 64, which comprises 256 40-bit entries. The code word table 64 provides each of the 256 40-bit code words in turn to the cross correlator 62, for correlation with the received sequence of de-masked soft bits. The cross correlator 62 determines which of the 40-bit code words received from the table most closely correlates to the sequence of soft bits (LLRs) received, whereby to then identify, from the code word table, the 8-bit sequence which when encoded led to the code word which most correlated with the received LLR sequence. The identified 8-bit sequence is then the most probable HS-SCCH Part 1 8-bitsequence, and is output as the HS-SCCH Part 1 bit sequence. Further details of this operation are given below.

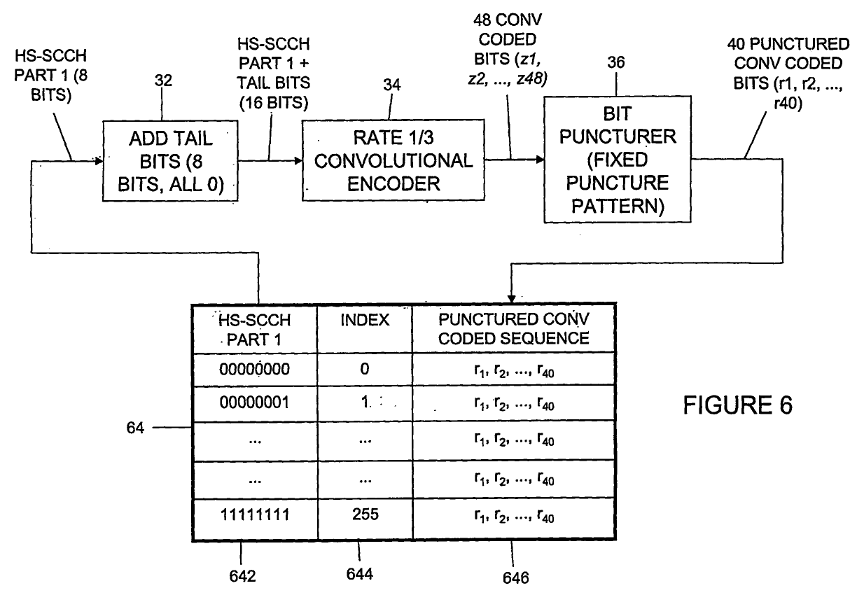

More particularly, FIG. 6 illustrates in more detail the code word table 64, and also illustrates how the code word table 64 is populated with the 40-bit code words. More particularly, as mentioned the code word table 64 comprises 256 entries, each of a 40-bit sequence. Preferably, the 256 sequences are stored in the table in order. Each 40 bit sequence rᵢ (r₁, r₂, . . . r₄₀) is stored in column 646 associated with the HS-SCCH Part 1 bit sequence which would, when coded, produce the 40 bit coded sequence. As shown in FIG. 6, the table 64 may comprise a column 642 storing the HS-SCCH Part 1 bit sequences, a second column 644 storing the column index values, and a third column 646 storing the 40 bit code word sequences. However, in a practical implementation it is not necessary to store both the HS-SCCH Part 1 bit sequences 642, as well as the index value 644, as provided code word sequences stored in the proper consecutive order, the index value stored in column 644 is, in binary terms, identical to the HS-SCCH Part 1 bit sequence which generates the corresponding code stored in column 646 to any particular index number. Therefore, in one embodiment, only the index column 644, in binary, and the 40 pit code word sequences in column 646 would need to be stored.

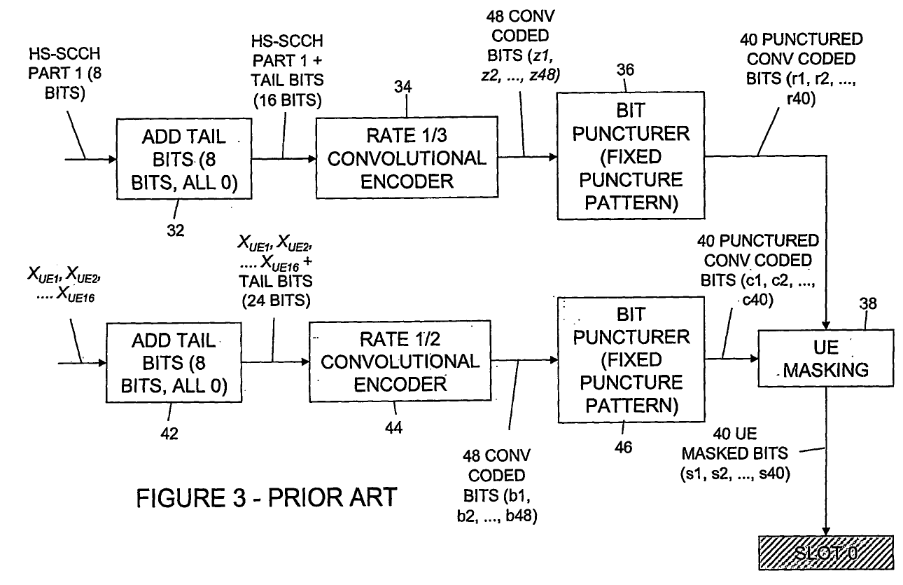

FIG. 6 also illustrates how the code word sequences stored in column 646 are generated. Generally, the generation of the code word sequences is performed in an identical manner as the coding performed, by the encoder in the Node B. That is, in order to generate the code word sequence for a particular HS-SCCH Part 1 sequence the HS-SCCH Part 1 sequence is input to the equivalent elements as are found in the encoder of Node B, to generate the code word sequence. Therefore, as shown in FIG. 6, the HS-SCCH Part 1 bit sequences are input into a tail bit adder 32, which adds 8 tail bits to the sequence, the tail bits all being 0. The resulting combination of the HS-SCCH Part 1 bits and the tail bits is then input into a rate ⅓ convolutional encoder 34, which is identical to the rate ⅓ convolutional encoder used in the Node B. The convolutional encoding results in 48 convolutionally coded bits, which are then input into a bit puncturer 36, which punctures the convolutionally coded bits according to a fixed puncture pattern. In this respect, the bit puncturer 36 of FIG. 6 is identical to the bit puncturer 36 of FIG. 3, and applies the same puncture pattern to the convolutionally coded bits. After puncturing therefore; a sequence of 40 punctured convolutionally coded bits rᵢ(r₁, r₂, . . . , r₄₀) is obtained, and this sequence is stored in the table 64 at the appropriate location in column 646 corresponding to the index having the same binary value as the HS-SCCH Part 1 sequence which generated the 40 bit code word. To fully populate the table, each of the 256 possible HS-SCCH Part 1 bit sequences is input to the encoder elements 32, 34 and 36 in turn, and the 256 40-bit code words thus obtained stored in the table 64, at the respectively appropriate places in column 646.

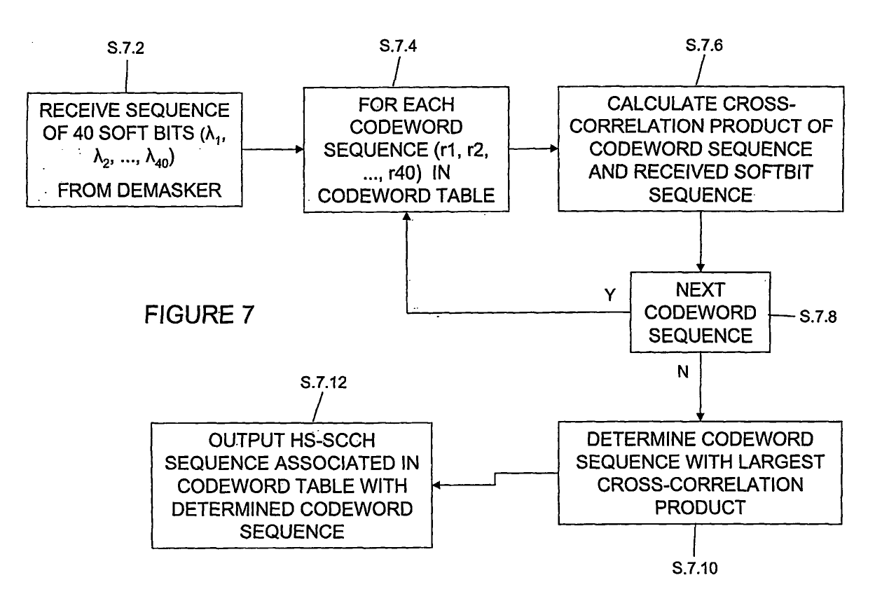

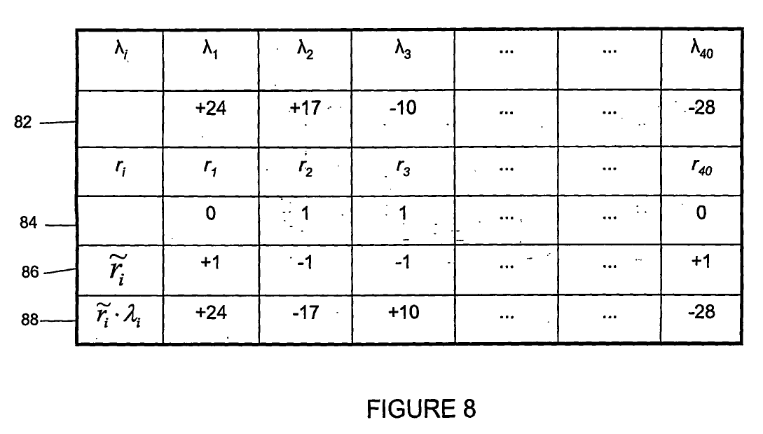

With the above in mind, FIGS. 7 and 8 illustrate in more detail the operation of the cross correlator 62, in determining which HS-SCCH Part 1 bit sequence corresponds to the received coded bit sequence. More particularly, at step 7.2 the cross correlator 62 receives the sequence of 40 de-masked soft bits λᵢ from the UE de-masker 52. Then, at step 7.4 the cross correlator 62 starts a processing loop, in order to correlate the received sequence of soft bits (LLRs) with each codeword sequence rᵢ stored in the code word table 64. The correlator takes each code void sequence in turn, and at step 7.6 calculates the cross correlation product of the code word sequence retrieved from the table 64 with the received soft bit sequence. The cross correlation operation performed is an element-wise dot product of the bits of the code word sequence from the table, having being subjected the code word sequence to a signum function, and the sequence of soft bits, as described further below.

FIG. 8 provides an example of the calculation of an example cross correlation product.

More particularly, FIG. 8 illustrates in row 82 example LLR values received. As shown, 40 LLR values are received at the cross correlator 62, from the UE de-masker 52. Row 84 shows an example 40 bit code word sequence received from the code word table 64. Each bit of the code word sequence is subjected to a signum function, to replace 0s with +1 values, and 1s with −1 values. An element wise dot product is then performed with the LLRs and the results of the signum function, to give the results shown in row 88. The cross correlation product is then the sum of the products set out in row 88. More formally, therefore:—

$$cross\_correlation \_product = \sum {\tilde{r}}_{i} \cdot {λ}_{i}$$

$$where : \tilde{{r}_{i}} = \{ \begin{matrix}+ 1 , {r}_{i} = 0 \\ - 1 , {r}_{i} = 1\end{matrix}$$

In practice the cross correlation ends up being simple sum of the LLRs, with the result of the signum function determining whether the λᵢ confidence value is added to or subtracted from the present running total.

Returning to FIG. 7, once the cross correlation product of one code word sequence and the received LLR sequence has been calculated, at step 7.8 an evaluation is performed as to whether there are any other code word sequences which need correlating with the received sequence. If so, the next code word sequence is obtained from the code word table 64, and processing then returns to step 7.6, via step 7.4. This processing loop is repeated until all 256 code words in the code word table 64 have had their cross correlation product with the received LLR sequence calculated.

Thereafter, processing proceeds to step 7.10, where the calculated cross correlation products are examined, and the code word sequence with the largest cross correlation product is determined. Then, the cross correlator 62 looks up in the code word table 64 the index of the code word sequence which was determined to have the largest cross correlation product, and is thereby able to determine the HS-SCCH Part 1 associated with the determined code word sequence. In this respect, as mentioned above, the index of the code word sequence which provided the largest cross correlation product in binary represents the HS-SCCH Part 1 sequence. Therefore, the cross correlator 62 is able to determine the most likely HS-SCCH Part 1 sequence corresponding to the received 40 bit soft bit sequence, and outputs the HS-SCCH sequence thus determined. The HS-SCCH Part 1 sequence thus output is then used in a conventional manner by the UE outside the scope of the present specification.

Thus, the preferred embodiment of the invention provides an alternative decoder and method of decoding for decoding Part 1 of the HS-SCCH. The embodiment provides several advantages over the conventional prior art, which typically makes use of a Viterbi decoder as it does not require de-puncturing of the received soft bits, and neither does it require implementation of a relatively complex Viterbi decoder. Instead, the received soft bit sequence can be used directly as an input to the cross correlation operation, correlating the received sequence with, in the preferred embodiment, pre-calculated code words stored in advance. In implementation terms, all that is required, therefore, is the cross correlator 62, which is relatively simple; as well as storage for the code word table, which comprises 256 40-bit entries. As a result, the decoder of the present embodiment is much more simple to implement, and in an integrated circuit implementation requires less chip area.

Additionally it is believed that the results of the correlation operation performed by the present embodiment are more accurate than the results obtained from a Viterbi decoder. Whilst bit errors during transmission can of course lead to errors in decoding, the correlation provided by the embodiment should provide a more accurate result than a maximum likelihood decoding operation, such as provided by a Viterbi decoder. Therefore, accuracy of decoding is also, it is believed, improved by use of the present embodiment.

Whilst we have described the preferred embodiment of the invention in terms of providing for the decoding of the HS-SCCH Part 1 channel at a UE using HSDPA, the principles of the invention may be applied to any channel decoding operation, and in particular those channels where the length of the bit sequence being transmitted is sufficiently short that the code word required to store the code word sequences used as an input to the cross correlator is not too large. In this respect, there is a trade off in embodiments of the invention between having to provide the code word table storage, versus the relative complexity of using the conventional Viterbi decoder. For example, should the bit sequences which an embodiment needs to decode be too long, resulting in an extremely large code word table, then, and particularly for IC implementations, the storage requirement for the code word table may mean that in fact the conventional Viterbi decoder is still preferable. However, for relatively short bit sequences requiring fast and accurate decoding, such as the HS-SCCH Part 1 sequence, the solution provided by the preferred embodiment of the invention is preferable.

Numerous variations may be made to the above described embodiment to provide further embodiments. For example, in a further embodiment instead of storing the 40-bit codewords in a store such as the table 64, the 40-bit codewords may be dynamically generated when required by the cross-correlator. Here, the table 64 is replaced with a tail bit adder 32, rate ⅓ convolutional encoder 34, and bit puncturer 36 which operate in exactly the same manner as the same numbered elements in the Node B encoder described previously in respect of FIG. 3. Then, when the decoding operation is to be performed, the 256 various possible HS-SCCH bit sequences are input in turn to the encoding elements 32, 34, and 36, and the resulting 256 40-bit codeword sequences then supplied when required to the cross-correlator. By keeping track of which index number codeword generated the largest cross-correlation product the most appropriate HS-SCCH Part 1 sequence to output can be identified.

This further embodiment is not as preferable as the preferred embodiment, as the dynamic generation of the 40-bit codewords every time is likely to be power intensive, which is not preferable for mobile devices. However, it does mean that the storage requirement for storing the 256 40-bit codewords is removed.

As another variation, in the preferred embodiment above we described how the codeword sequences are stored in column 646 of table 64 together with the index numbers in column 644. However, in another embodiment of the invention it is not necessary to store the index numbers in column 644, and only the 40-bit codewords need be stored, in order, in column 646. In this case, when the codewords are processed in turn by the cross-correlator 62, when the codeword with the maximum correlation is found the correlator “remembers” it as the k^{th} processed codeword in the list. In this way it is then no longer necessary to read the index from the table, and nor is it necessary to store the HS-SCCH message, as the index is known to be k and the message is known to be the binary representation of k.

On a related matter, in this alternative embodiment, neither is it necessary to strictly follow the processing of FIG. 7, where the cross-correlation products for each of the codewords are calculated, and then the maximum found after all the cross-correlation products have been found for each codeword. Instead, as the cross-correlation products are calculated in turn, the cross-correlator can keep track of the maximum cross-correlation product thus far obtained, together with which of the codewords in terms of the index k thereof produced the maximum value. In this way, after all of the cross-correlation products have been generated it is then immediately apparent which codeword generated the largest cross-correlation product, and its index in binary is then the same as the HS-SCCH message.

As another variation, in the above described preferred embodiment we make use of a cross-correlation operation which operates on the confidence values of soft decisions to determine the “similarity” between the code words and the received bit sequence, with the code-word with the lowest “distance” as measured by having the highest cross-correlation product then being selected. In other embodiments, instead of using cross-correlation as the codeword comparison operation, any other “similarity” finding operation may be used, for example, the Hamming distance, or Hamming correlation. Other distance or correlation measurements may also be used as the similarity measure or metric. In this respect, a distance metric tends to relate to a measure of how similar two sequences are in terms of the lower the distance the greater the similarity, the higher the distance the more dissimilar. Conversely, a correlation metric tends to relate to a similarity measure where the higher the correlation the higher the similarity, the lower the correlation the lower the similarity (or the higher the dissimilarity).

Moreover, in other embodiments instead of using soft bits hard decision bits may be used, in which case the Hamming distance or correlation is particularly appropriate. In such an embodiment the stored codewords are compared with the received hard bit sequence in turn, and a Hamming distance found for each codeword. The codeword which provides the minimum Hamming distance is then selected, and its index in the table represents, in binary, the HS-SCCH message.

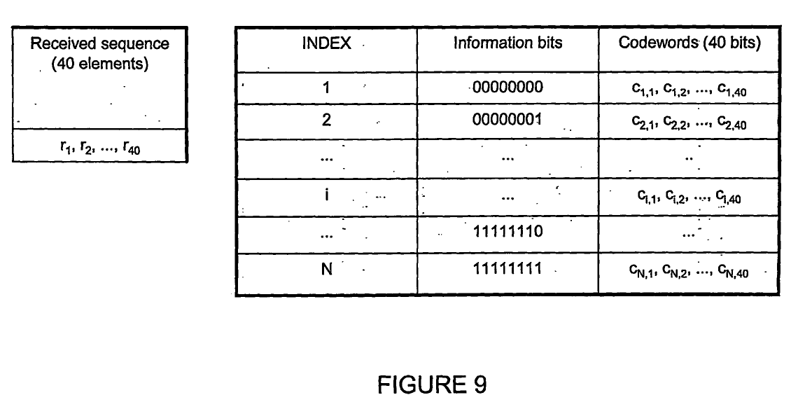

More particularly, and with reference to the table in FIG. 9, generally speaking, the decoder has to find the index i₀ of the “closest” codeword to the received sequence in the list of possible codewords:

$${i}_{0} = {ArgMin}_{1 \leq i \leq N} d ( λ , {r}_{i} )$$

where d(λ,rᵢ) is the distance between
the received sequence λ=(λ₁, λ₂, . . . , λ₄₀)
and the i^{th} possible codeword r=(r_{i,1}, r_{i,2}, . . . r_{i,40})

When using hard-decisions, the received sequence λ is a series of bits (0s and 1s). Then the most likely transmitted sequence is found with the Hamming distance, defined as:

$${d}_{H} ( λ , {r}_{i} ) = {\sum }_{k = 1}^{40} {λ}_{k} ⊕ {r}_{i , k}$$

where ⊕ is the modulo 2 addition

In other words, the Hamming distance counts how many bits are different in the 2 sequences λ and r

Also, note that minimizing the Hamming distance is equivalent to maximizing the correlation:

$${\sum }_{k = 1}^{40} \overline{{λ}_{k} ⊕ {r}_{i , k}} \overline{a}$$

where the operator [symbol] is the logical negation (this sum counts how many bits are identical in the 2 sequences).

When using soft-decisions, the received sequence λ is a series of real values (possibly quantized, e.g. integers between −32 and 32). Then the distance to be used is the (squared) Euclidean distance, defined as:

$${d}_{E}^{2} ( λ , {r}_{i} ) = {\sum }_{k = 1}^{40} {( {λ}_{k} - {\tilde{r}}_{i , k} )}^{2}$$

$$where \text{:} {\tilde{r}}_{i , k} = {( - 1 )}^{{r}_{i , k}} = \{ \begin{matrix}+ 1 & if & {r}_{i , k} = 0 \\ - 1 & if & {r}_{i , k} = 1\end{matrix}$$

Note that using the squared Euclidean distance rather than the Euclidean distance does not make any difference, as the result does not matter, only the relative order (which one is the minimum).

Also, note that \tilde{r}_{i,k} is the expected soft decision, if the i^{th} codeword was sent, and there is no error. In such a case:

$${d}_{E}^{2} ( λ , {r}_{i} ) = {\sum }_{k = 1}^{40} {λ}_{k}^{2} + {\sum }_{k = 1}^{40} {\tilde{r}}_{i , k}^{2} - 2 {\sum }_{k = 1}^{40} {λ}_{k} \cdot {\tilde{r}}_{i , k}$$

Here, the term relating to the sum of the square of the received soft bits does not depend on the index of the processed codeword, and in fact neither does the term relating to the sum of the square of the i^{th} codeword, as all such contributions are equal to 1 i.e.

\tilde{r}_{i,k}²=1

Therefore, finding the codeword which is the closest to the received sequence with respect to the Euclidean distance is equivalent to finding the codeword which maximizes the correlation:

$${\sum }_{k = 1}^{40} {λ}_{k} \cdot {\tilde{r}}_{i , k}$$

Note also that the Euclidean distance comes from the assumed Gaussian nature of the noise n:

$$P ( n ) = \frac{1}{\sqrt{2 π}} {e}^{\frac{{n}^{2}}{2}}$$

Therefore the most likely sequence is the closest one with respect to the Euclidean distance (n²).

If another noise characteristic was assumed, then the most likely sequence would be found with respect to another (adapted) distance. In such a case, it may not be sufficient to merely look at the element wise dot product as the cross-correlation product.

Therefore, as will be apparent, in other embodiments different similarity measurements between the received bit sequence and the codewords may be used, and moreover the similarity measurement used will typically depend on whether hard or soft bits are being used to represent the received bit sequence. In this respect, soft bits are highly preferable, providing an estimated 2 dB of performance gain over a hard bit implementation.

Moreover, in the above described preferred embodiment we have described how the embodiment is particularly adapted for decoding the HS-SCCH Part 1 messages as described in the Rel. 5 standard 3GPP TS 25.212 V.5.10.0. However, the embodiment is not limited to use with HS-SCCH Part 1 messages in accordance with this 3GPP Technical Standard, and can also be used with HS-SCCH Part 1 messages as defined in later versions of the Standard. For example, the most recent (prior to the priority date) version of the Standard is 3GPP TS 25.212 V.7.6.0 Rel. 7, dated June 2007, which describes, at sections 4.6, 4.6A, and 4.6B, three different versions of the HS-SCCH channel, being Type 1, Type 2, and Type M. The HS-SCCH Type 1 and HS-SCCH Type 2 channels have their respective Part 1 messages in the same form as described previously in V.5.10 (Rel. 5), comprising 8 bits. In this case, the embodiments described previously can therefore be used for the decoding of Part 1 of such channels, in exactly the same manner as described.

For Type M HS-SCCH, however, the Part 1 messages have 12 bits, rather than 8 bits, meaning that 4096 possible 12-bit Part 1 messages result. However, despite being 12-bits in length, and then having 8 tail bits added and being rate ⅓ convolutionally encoded (resulting in 60 bits), a greater degree of puncturing is used to generate 40-bit-codewords. Hence, the length of the codewords for Type M HS-SCCH Part 1 messages is the same as previously, but there are simply more possible values (16 times as many). To use the techniques of the embodiments of the present invention would therefore mean that a table of 4096 40-bit codewords would be required, or that 4096 40-bit codewords would need to be dynamically generated for every decoding operation, and hence many of the advantages provided by the embodiments of the invention may be lost. Nevertheless, some advantages may still, be obtained, depending on the relative complexity of the alternative Viterbi decoder.

Various further additions and modifications will be apparent to the intended reader being a person skilled in the art and which may be made to the above described embodiments to provide further embodiments, any and all of which are intended to fall within the scope of the present invention as defined by the appended claims.

1. A method of decoding a received coded bit sequence, comprising:
obtaining a plurality of codewords which said coded bit sequence may possibly represent;
for substantially each of the plurality of codewords, calculating a similarity measure with the received coded bit sequence to determine one of the codewords which most closely matches the coded bit sequence;
identifying an input bit sequence which, when encoded in the same manner as the received coded bit sequence, produces said determined codeword; and
outputting said identified input bit sequence to represent the decoded received coded bit sequence.

2. A method according to claim 1, wherein the received coded bit sequence is Part 1 of a High Speed Shared Control CHannel (HS-SCCH) of a High Speed Downlink Packet Access (HSDPA) downlink from a Node B to a UE.

3. A method according to claim 2, wherein the method is performed at a UE.

4. A method according to claim 1, wherein said obtaining includes:
storing said codewords, each codeword being stored so as to indicate the input bit sequence which, when encoded in the same manner as the received coded bit sequence, produces said codeword.

5. A method according to claim 4, wherein said stored codewords are produced by encoding each possible value of the input bit sequence in the same manner of encoding as the received coded bit sequence, and storing each produced codeword in a table.

6. A method according to claim 4, wherein said codewords are stored in order, such that the order of the codeword indicates the input bit sequence.

7. A method according to any of claim 1, wherein said obtaining includes:
generating said codewords when required, each codeword being generated by encoding, in the same manner as the received coded bit sequence was encoded, a respective input bit sequence.

8. A method according to claim 1, wherein the similarity measure is a correlation measure between the received coded bit sequence and an obtained codeword.

9. A method according to claim 1, wherein the similarity measure is a distance measure between the received coded bit sequence and an obtained codeword.

10. An apparatus comprising a decoder, the decoder comprising:
i) a simililarity measurement calculator configured in use to calculate a similarity measure for substantially each of a plurality of codewords which said received coded bit sequence may possibly represent so as to determine one of the plurality of codewords which most closely matches the received coded bit sequence;
ii) a bit sequence identifier configured in use to identify an input bit sequence which, when encoded in the same manner as the received coded bit sequence produces said determined codeword; and
iii) an output at which said identified input bit sequence is output so as to represent the decoded received coded bit sequence.

11. An apparatus according to claim 10, wherein the received coded bit sequence is Part 1 of a High Speed Shared Control CHannel (HS-SCCH) of a High Speed Downlink Packet Access (HSDPA) downlink from a Node B to a UE.

12. An apparatus according to claim 10, and further comprising:
a store storing said codewords, each codeword being stored so as to indicate the input bit sequence which, when encoded in the same manner as the received coded bit sequence, produces said codeword.

13. An apparatus according to claim 12, wherein said stored codewords are produced by encoding each possible value of the input bit sequence in the same manner of encoding as the received coded bit sequence, said store comprising a table.

14. An apparatus according to claim 12, wherein said codewords are stored in the store in order, such that the order of the codeword indicates the input bit sequence.

15. An apparatus according to claim 10, and further comprising:
a codeword generator for generating said codewords when required, each codeword being generated by encoding, in the same manner as the received coded bit sequence was encoded, a respective input bit sequence.

16. An apparatus according to claim 10, wherein the similarity measure is a correlation measure between the received coded bit sequence and an obtained codeword.

17. An apparatus according to claim 10, wherein the distance measure is a distance measure between the received coded bit sequence and an obtained codeword.

18. A UE comprising an apparatus according to claim 1.

19-20. (canceled)

21. An apparatus comprising:
a receiver arranged to receive in use data from a High Speed Shared Control Channel (HS-SCCH) corresponding to a High Speed Downlink Packet Access (HSDPA) downlink, the HS-SCCH data being configured in at least two parts, being a first part and a second part, each part being separately convolutionally encoded from the other part; and
a first decoder arranged to decode the first part of the HS-SCCH data, the decoder comprising:
a store storing possible codeword values of the first part of the HS-SCCH and associated unencoded values; and
a similarity matching unit arranged in use to compare a received encoded first part data word with the stored codeword values to decode the received encoded first part data word whereby to identify the corresponding unencoded value.

22. An apparatus according to claim 21, further comprising:
a second decoder being a convolutional decoder arranged to decode the second part of the HS-SCCH.
